(19) United States
(12) Patent Application Publication
(10) Pub. No.: US 2026/0117588 A1
(43) Pub. Date: Apr. 30, 2026

(54) Improved Rolling Shutter With Fixed And Orientable Slats

(71) Applicant: EFFETRADE S.R.L., Grottaglie (IT)

(72) Inventors: Ignazio Donatelli, Grottaglie (TA) (IT); Samuele Donatelli, Grottaglie (TA) (IT); Teresa Donatelli, Gottaglie (TA) (IT); Danilo Tribenga Quaranta, Grottaglie (TA) (IT)

(73) Assignee: EFFETRADE S.R.L., Grottaglie (IT)

(21) Appl. No.: 19/469,586

(22) PCT Filed: Mar. 26, 2024
(86) PCT No.: PCT/IB2024/052875

§ 371 Date: Sep. 26, 2025

(30) Foreign Application Priority Data
Mar. 31, 2023 (IT) 102023000006390

(51) Int. Cl. E06B 9/15

(52) U.S. Cl. CPC E06B 9/15; E06B 2009/1566; E06B 2009/1577

(57) ABSTRACT

A shutter of the type comprising a plurality of slats, each in turn comprising a wing movable between a closed position and an opening position in which it is inclined, generally outwards, with respect to the vertical direction, so as to allow the passage of air between the slats is provided. The rolling shutter improves the alignment of the slats in order to avoid their warping during the step of ascent and descent of the shutter, thus improving the closure of the slats themselves.

### CROSS-REFERENCE TO RELATED APPLICATIONS

The present application is a 371 National Stage entry of PCT/IB2024/052875 filed on Mar. 26, 2024, which claims the benefit of foreign priority to Italian Patent Application No. 102023000006390, filed on Mar. 31, 2023, in the Italian Republic, the disclosures of which are incorporated by reference herein.

### TECHNICAL FIELD

The present disclosure concerns an improved rolling shutter of the type comprising a plurality of slats, each in turn comprising a wing movable between a closed position and an opening position in which it is inclined, generally outwards, with respect to the vertical direction, so as to allow the passage of air between the slats.

The present disclosure constitutes an enhancement aimed at improving the alignment of the slats in order to avoid their warping during the step of ascent and descent of the shutter, thus improving the closure of the slats themselves.

### BACKGROUND

Roller shutters or shutters provided with slats having orientable wings are known from the state of the art, in order to allow the passage of air even when the shutter is almost completely lowered.

This type of shutters of known type allows to obtain an intermediate configuration between the one completely open, wound around the roller, and the one completely closed in which the shutter is lowered, extended by the roller, and with the slats adjacent to each other to form a continuous and closed surface. In such an intermediate configuration the slats, or the portions of slats constituting the wings, are not arranged vertically but inclined with respect to the vertical direction to allow the passage of air.

These known shutters comprising a pair of side guides configured both to guide the slats from the wound configuration to the extended configuration, and to guide the movable wings from the closing configuration to the opening configuration.

A known type of shutter provided with orientable slats is described in Italian patent application no. 102016000038667, which published as IT UA20162606, on Oct. 14, 2017, of the same Applicant.

This known shutter comprises a plurality of adjacent slats suitable for passing from a roller wound configuration to an extended configuration, and each slat in turn comprises a wing which can be movable or fixed, each movable wing being movable between a closing configuration, in which the extended shutter is in a vertical position and creates with the subsequent wing a substantially closed and continuous surface, and an opening configuration, in which it is inclined with respect to the vertical position so as to allow the passage of air between the slats.

In particular, the shutter object of patent application no. 102016000038667 allows the containment of the encumbrances, in particular of the thickness of the side guides. In fact, in both the closing and opening configurations of the wings, the shutter has the same side encumbrance, without any elements or portions being offset with respect to the vertical plane of the shutter, in particular in the opening position of the wings, which allows to contain the transverse encumbrance of the side guides.

This aspect is particularly advantageous as it allows the creation of guide profiles and/or side installation ducts of the shutter that are much thinner than what can be obtained with the solutions known from the state of the art.

This result is achieved thanks to the presence of a connecting rod element placed between the guide and the movable wing and adapted to perform the opening movement of the wings themselves.

This solution is however not free from some drawbacks.

In particular, the present disclosure aims at improving the solution of known type so as to allow to the slats to open and orient themselves during the step of ascent and descent of the shutter while improving the alignment, and thus avoiding the warping of the slat and, consequently, the non-perfect closure of the same, which entails the presence of drafts of air and unwanted passages of light.

### SUMMARY

In light of the above, the task of the present disclosure is that of realizing an improved rolling shutter of the type comprising a plurality of movable slats and a plurality of fixed slats, which overcomes the drawbacks that afflict the prior art, in particular with regard to the closure of the slats.

Within the scope of this task, the object of the present disclosure is that of realizing an improved rolling shutter of the type comprising a plurality of movable slats and a plurality of fixed slats, capable of avoiding the warping of the slats, fixed and movable, which causes the non-perfect closure of the slats themselves, thus eliminating the unwanted passage of air and light.

A further object of the present disclosure consists in the fact of realizing an improved rolling shutter of the type comprising a plurality of movable slats and a plurality of fixed slats that solves the drawbacks highlighted that afflict the state of the art while maintaining a small encumbrance, in particular being able to be installed within guides that have the same compact encumbrance as the guides used for shutters of known type.

The task set forth above, as well as the purposes mentioned and others that will become clearer later, are achieved by a rolling shutter of the type comprising a plurality of fixed slats and a plurality of movable slats according to claim 1.

Other features are provided in the dependent claims.

### BRIEF DESCRIPTION OF THE DRAWINGS

Further characteristics and advantages of the present disclosure will become more apparent from the exemplary but non-limiting description of a preferred aspect of the present disclosure illustrated with the aid of the attached drawings in which:

FIG. 1 illustrates a rolling shutter configuration of the type comprising a plurality of fixed and movable slats according to what is known from the state of the art in a configuration in which all the slats are closed;

FIG. 2 illustrates a rolling shutter configuration of the type comprising a plurality of fixed and movable slats according to what is known from the state of the art in a configuration in which all the openable slats are open;

FIG. 3 shows an overall perspective view of the rolling shutter according to the present disclosure in a lowered configuration and with the slats closed;

FIG. 4 shows an overall perspective view of the rolling shutter of FIG. 3 in a lowered configuration and with the openable slats open;

FIG. 5 illustrates an exploded front perspective view of an openable slat of the shutter according to the present disclosure;

FIG. 6 illustrates an exploded rear perspective view of the openable slat of FIG. 5;

FIG. 7 illustrates a sectional side view with a vertical plane of the shutter according to the present disclosure in a configuration in which the openable slats are closed;

FIG. 8 illustrates the same sectional side view of FIG. 7 in a configuration in which the openable slats are open;

FIG. 9A, FIG. 9B and FIG. 9C show, by way of example, some possible configurations of the rolling shutter according to the present disclosure that differ in the different number and positioning of the movable connection elements that cause the opening of the slats.

### DETAILED DESCRIPTION

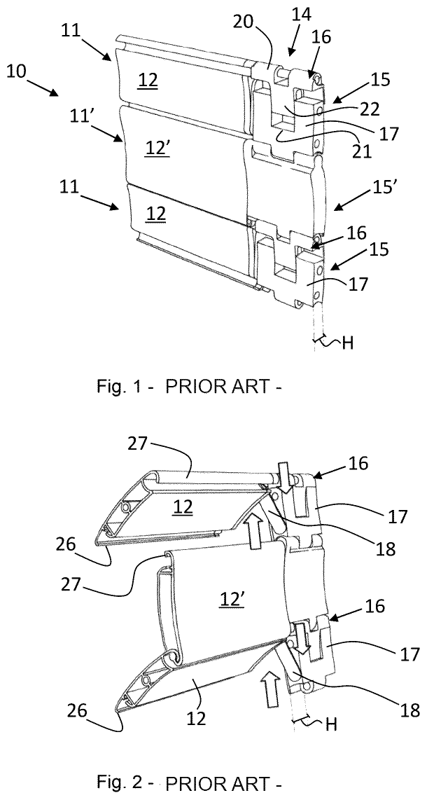

With particular reference to FIGS. 1 and 2, a rolling shutter of the type comprising a plurality of fixed slats and a plurality of movable wings of the type known from the state of the art is shown, in particular according to patent application no. 102016000038667 of the same Applicant.

Such a rolling shutter 10 is of the type comprising a plurality of movable slats 11 and a plurality of fixed slats 11′interspersed between them in succession.

The shutter, or roller shutter, is movable between a roller wound configuration, an extended configuration of total closure and an extended configuration with said movable slats 11, in a raised or inclined position to allow the passage of air even with the lowered shutter.

According to what is known, each movable slat 11 comprises a wing 12 which is movable between a closing configuration, in which it is in a vertical position realizing with the subsequent fixed wing 12′a continuous barrier, and an opening configuration, in which it is raised in an inclined position with respect to the vertical position so as to realize a passage of air between two adjacent wings 12.

The shutter further comprises a pair of side guides 14 configured both to guide the slats 11, 11′ from the wound configuration to the extended configuration of total closure, and to impose to the movable wings 12 the lifting movement from the closing configuration to the inclined opening configuration.

In both the closing and opening configurations of the movable wings 12, the side guides 14 have substantially the same side encumbrance H, since there are no offset elements configured to act with a lever effect with respect to the vertical plane of the shutter 10. The side guides 14 advantageously comprise a plurality of movable guide elements 15, associated with the movable slats 11, and a plurality of fixed guide elements 15′ associated with the fixed slats 11′.

Each movable guide element 15 comprises a first movable portion 16 constrained to the relative movable wing 12 and a second fixed portion 17 constrained to the underlying fixed guide 15′.

The first and second portions 16, 17 of the movable guide 15 are slidable between them in an at least partially telescopic manner between a spaced position and a position in which they are compacted.

When the first and second portions 16, 17 of the movable guide 15 are spaced from one another, as shown in FIG. 1, the movable wing 12 forms with the adjacent fixed wing 12′a substantially continuous surface, thus closing the passages between the adjacent wings. The shutter is in a closed configuration.

Conversely, when the adjacent wings 16, 17 of the movable guide 15 are retracted together according to what is visible, for example, in FIG. 2, the movable wing 12 is opened by rotation outwards creating an opening that allows the passage of air between the movable wing 12 and the adjacent fixed wing 12′.

In the solution known from the Italian patent application no. 102016000038667, this motion to open the movable wing 12 is commanded by a connecting rod arm 18 having a lower end 30 connected to the second fixed portion 17 and an upper end 31 connected to the movable wing 12 so that, when the movable guide elements 15 are in a spaced position, the connecting rod arm 18 is in a substantially vertical position and keeps the relative movable wing 12 in a closing vertical position, while when the movable guide elements 15 are in a close position the connecting rod arm 18 is rotated, according to what is visible in FIG. 2, by rotating and opening the relative movable wing 12 outwards.

Advantageously, in this solution of known type, the movable guide 15 comprises a first T-shaped portion, where the head portion 20 of said T-shaped portion of said movable guide 15 is constrained to the upper portion of the relative wing 12 by means of a pin 19 (visible in FIG. 1), and a second U-shaped portion 17, where in the cavity 21 of said second portion the stem portion 22 of the first T-shaped portion 16 is movably fitted.

According to what is shown in the attached drawing figures, the movable wings 12 advantageously comprise a lower tab-shaped portion 26 which in the closing configuration couples with a corresponding upper tab-shaped portion 27 formed superiorly the fixed wing 12′, lowerly adjacent to said movable wing 12.

The operation of this type of shutter is simple: from the roller wound configuration, by lowering the shutter it is switched to a condition of total closure with all the wings 12, 12′ arranged vertically, to form a substantially continuous surface. The situation is illustrated in FIG. 1, where it can be noted that the wings 12, 12′ are closed while the first and second portions 16, 17 of the movable guide 15 are spaced from one another. In this closed configuration the movable wing 12 forms with the adjacent fixed wing 12′ a substantially continuous surface, thus closing the passages between the adjacent wings.

At this point, a further lowering of the slats means that the T-shaped portion of the movable guide 15 penetrates into the seat 21 of the relative U-shaped portion, thus commanding the rotation of the connecting rod 18 according to what is visible in FIG. 2.

Since the connecting rod 18 is constrained on one side to the movable wing 12, the latter is rotated reaching the open configuration inclined with respect to the vertical direction.

Conversely, by raising the shutter again, firstly the T-shaped portion of the movable guide 15 is raised spacing again the first and second portions 16, 17 of the movable guide 15 from each other and releasing the movable wing 12 which returns to its vertical closing position.

With respect to this configuration of rolling shutter described in patent application no. 102016000038667 in the name of the same Applicant, the present disclosure introduces an important enhancement that allows to avoid the inconvenience represented by the warping of the slats, fixed and movable, which causes the non-perfect closure of the slats themselves, thus eliminating the unwanted passage of air and light when the shutter is lowered.

This warping is due to the positioning and configuration of the pushing connecting rods 18, which achieve a precise, concentrated push on the movable wings.

The rolling shutter 100 object of the present disclosure is visible by way of example in the attached FIGS. from 3 to 9C.

This solution allows to eliminate the connecting rod 18 and to provide for the opening of the movable wings 120 by means of a further movable connection element 300, visible in particular for example in the section of FIG. 6, which is advantageously associated with each of said movable wings 120 superiorly at a first upper end 310 thereof folded hook-like toward the front face of the movable wing 120 and adapted to fit into a corresponding receiving seat 120a formed at an upper edge of the body of said movable wing 120, and which constitutes a first point of engagement and rotation of said movable element 300 with respect to said wing 120. Said movable connection element 300 is further associated at a second lower end 320 thereof, which constitutes a second point of engagement and rotation, to a lower fixed slat 400.

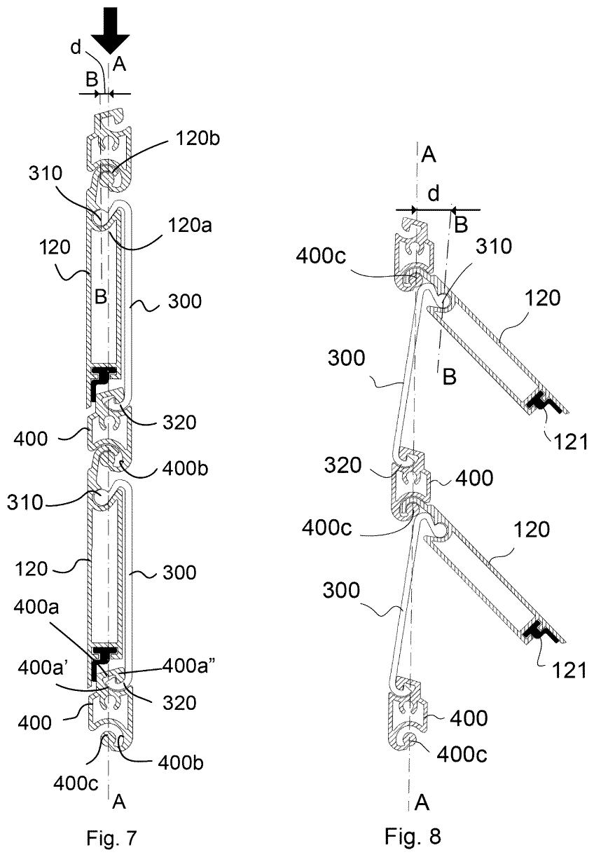

With particular reference for example to FIGS. 7, 8 and 9A to 9C, each movable wing 120 is connected by means of said movable connection element 300 to a fixed slat 400 arranged inferiorly with respect thereto.

More particularly, with reference to the sectional view with a vertical plane of FIGS. 7 and 8, said receiving seat 120a formed on the upper edge of each movable wing 120 has the shape of a rounded recess suitable for receiving said first hook-shaped end 310 of said movable element 300, and said fixed slat 400 comprises at the upper edge a seat 400a thereof shaped with a curved section 400a′ and a retaining tooth 400a″ into which said second lower end 320 of said movable element 300 is slidably fitted.

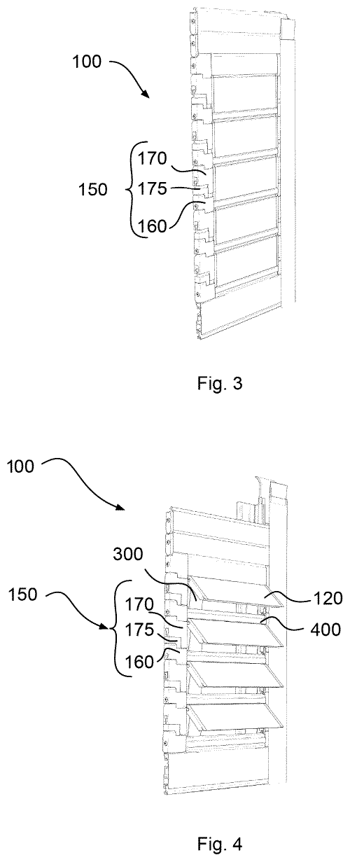

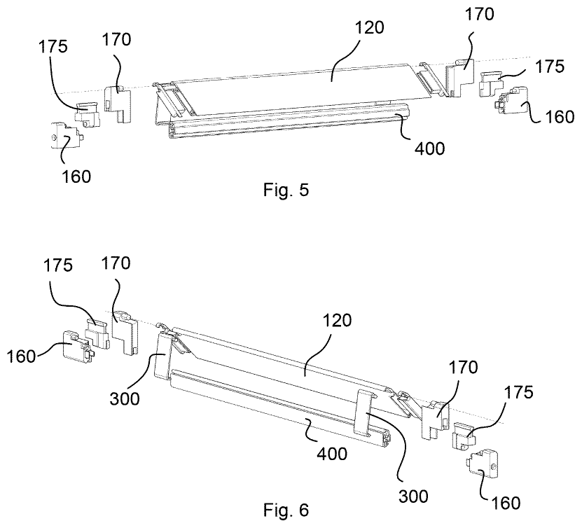

The operation of the shutter according to the present disclosure is shown again in FIGS. 7 and 8: from the roller wound configuration, by lowering the shutter it is switched to a condition of total closure with all the wings 120, 400 arranged vertically (FIGS. 3 and 7), to form a substantially continuous surface in which the movable wings 120 and the fixed slats 400 are closed while the fixed 160 and movable 170 portions of the movable guide 150 are spaced from one another thanks to the sliding in the vertical direction of the movable portion 170 with respect to the sliding element 175 that allows the sliding of said movable portion 170 with respect to the fixed portion 160 of the movable guide, as visible in the exploded views of FIGS. 5 and 6.

In this closed configuration the movable wing 120 forms with the adjacent fixed slat 400 a substantially continuous surface, thus closing the passages between the adjacent wings. Advantageously, a gasket 121 can be associated with the free end of said movable wing 120, according to what is shown in the sections of FIGS. 7 and 8.

By keeping on lowering the shutter, the movable portion 170 of the guide 150 is compacted on the sliding element 175 causing the reciprocal approach of the movable 170 and fixed 160 portions of the movable guide 150 which are compacted according to what is visible in FIG. 4, while the fixed slats 400 move closer to each other along the direction of the vertical axis A shown in FIGS. 7 and 8.

Said vertical axis A is the axis passing through the centre of rotation 400c of said movable wing 120 with respect to said fixed slat 400, and the fact that the first upper end 310 of the connection element 300 is rotatably housed within the seat 120a which results, with respect to said vertical axis A, offset anteriorly by a distance d-which increases (see axis B) with the rotation of the movable wing according to what is visible in FIGS. 7 and 8—with respect to the centre of rotation of said second lower end 320 housed within said fixed slat 400, causes the rotation of the connection element 300 outwards according to what is visible in FIG. 8, and the consequent rotation of the movable wing 120 and, therefore, the opening of the wing with respect to the lower fixed slat 400.

In performing this rotation movement, the connection element 300 rotates with respect to the lower fixed slat 400, in particular the second lower end 320 thereof slides guided by said curved section 400a′ so as to rotate, with reference to FIG. 8, in a clockwise direction thus causing the opening thrust of the movable wing 120.

The closing operation is quite similar: when the shutter is raised, the fixed slats 400 are spaced apart from each other so that said movable wings 120 can return to a vertical position according to what is visible in FIG. 3, and with them also said connection elements 300.

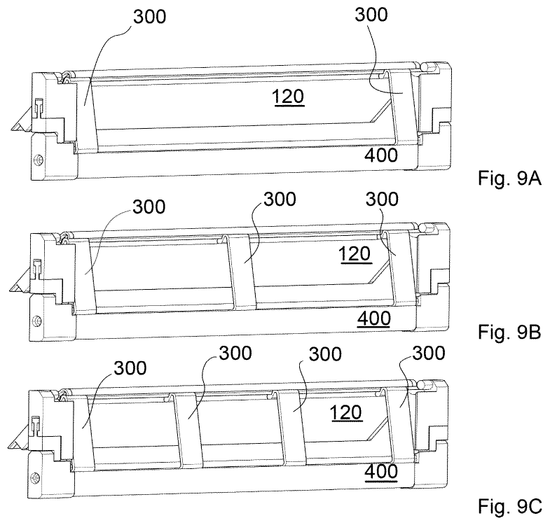

Preferably, multiple connection elements 300 may be provided according to the present disclosure. In particular, FIG. 9A shows an aspect comprising two connection elements 300, while FIG. 9B shows an alternative aspect comprising three connection elements 300, and FIG. 9C shows an alternative aspect comprising four connection elements 300. The possibility of providing two or more connection elements 300 associated with the same lower fixed slat 400 for the movement of the same movable wing 120 allows to make the structure of the shutter more rigid avoiding possible flexions of the movable wing 120 and/or of the lower fixed slat 400.

Also in the case of the shutter according to the present disclosure, said movable wings 120 advantageously comprise an upper claw-shaped portion 120b that is received and couples within a corresponding lower seat 400b of said lower slat 400 which seat in turn has a curved development so as to allow the rotary movement of said claw 120b within said seat 400b in the opening and closing movement of the movable wing 120.

This configuration ensures that in the ascent and descent movement of the shutter the movable slats 120 act as connection hooks between two adjacent fixed slats 400, together with the first and second portions 160, 170 and said sliding connection element 175 of the movable guide 150, in order to allow the shutter winding and unwinding movement.

It has been found that the rolling shutter of the type comprising a plurality of fixed slats and a plurality of movable wings according to the present disclosure fulfils the task as well as the purposes set as it allows to avoid the warping of the slats and/or wings during the opening and closing step, in particular by distributing the opening thrust of the openable wings along a wider section of the wing itself.

The rolling shutter thus conceived is susceptible to numerous modifications and variants all falling within the scope of the inventive concept.

Furthermore, all the details can be replaced by other technically equivalent elements.

In practice, any materials can be used according to requirements, as long as they are compatible with the specific use, the dimensions and the contingent shapes.

1. A rolling shutter of the type comprising a plurality of fixed slats and a plurality of movable wings arranged alternately between them to make a shutter or roller shutter movable between a roller wound configuration, an extended configuration of total closure in which said movable wings are closed and arranged in a substantially vertical position and an extended configuration with said movable wings rotated with respect to the vertical direction so as to realize a passage for air between said movable wing and the subsequent fixed slat characterized in that it further comprises at least one movable connection element which is associated, at a first upper end thereof folded hook-like toward the front face of the movable wing with one of said movable wings and configured to fit into a corresponding receiving seat formed at an upper edge of the body of said movable wing realizing a first point of engagement and rotation of said movable connection with respect to said wing, said movable connection element being further associated with a lower fixed slat at a second lower end thereof constituting a second point of engagement and rotation of said movable connection element, wherein said seat results, with respect to a vertical axis passing through the centre of rotation of said movable wing with respect to said fixed slat offset by a distance with respect to the centre of rotation of said second lower end housed within a subsequent fixed slat.

2. The rolling shutter according to claim 1, further comprising a pair of movable side guides each movable side guide in turn comprising a plurality of fixed guide portions each associated with one of said fixed slats and a plurality of movable guide portions each associated superiorly with a movable wing, and inferiorly with one of said fixed guide portions by means of a sliding connection element provided between said movable portion and said fixed portion which are thus at least partially telescopically slidable between them.

3. The rolling shutter according to claim 2, wherein said movable portion is sliding with respect to said fixed guide portion by means of said sliding connection element between a close position, in which said movable portion is compacted on said sliding connection element and on said fixed portion and said movable wing is raised, and a spaced position in which said movable portion is telescopically moved away from said sliding connection element and said movable wing is in a substantially vertical closed position.

4. The rolling shutter according to claim 1, wherein said receiving seat of said first upper end folded hook-like toward the front face of the movable wing formed on the upper edge of each movable wing is configured to be a rounded recess suitable for receiving said first hook-shaped end of said movable connection element.

5. The rolling shutter according to claim 1, wherein said fixed slat comprises at an upper edge thereof a seat shaped with a curved section and a retaining tooth into which said second lower end of said movable connection element is slidably fitted.

6. The rolling shutter according to claim 1, wherein said movable wings comprise an upper claw-shaped portion that is received and couples within a corresponding lower seat of said lower slat which seat in turn has a curved development so as to allow the rotary movement of said claw within said seat in the opening and closing movement of the movable wing.

7. The rolling shutter according to claim 1, wherein said movable connection element is rotatably movable with respect to the relative fixed slat to which the second end thereof is associated.

8. The rolling shutter according to claim 1, wherein it comprises two of said movable connection elements, each placed in a position adjacent to one of said movable side guides.

9. The rolling shutter according to claim 1, wherein it comprises three of said movable connection elements, two movable connection elements each being placed in a position adjacent to one of said movable side guides, and a third movable connection element being placed substantially halfway along the longitudinal extension of said movable wing.

10. The rolling shutter according to claim 1, characterized in that it comprises four of said movable connection elements, two movable connection elements each being placed in a position adjacent to one of said movable side guides and the other two movable connection elements being placed substantially equidistant from each other along the longitudinal extension of said movable wing.

11. The rolling shutter according to claim 2, wherein said receiving seat of said first upper end folded hook-like toward the front face of the movable wing formed on the upper edge of each movable wing is configured to be a rounded recess suitable for receiving said first hook-shaped end of said movable connection element.

12. The rolling shutter according to claim 3, wherein said receiving seat of said first upper end folded hook-like toward the front face of the movable wing formed on the upper edge of each movable wing is configured to be a rounded recess suitable for receiving said first hook-shaped end of said movable connection element.

13. The rolling shutter according to claim 2, wherein said fixed slat comprises at an upper edge thereof a seat shaped with a curved section and a retaining tooth into which said second lower end of said movable connection element is slidably fitted.

14. The rolling shutter according to claim 3, wherein said fixed slat comprises at an upper edge thereof a seat shaped with a curved section and a retaining tooth into which said second lower end of said movable connection element is slidably fitted.

15. The rolling shutter according to claim 4, wherein said fixed slat comprises at an upper edge thereof a seat shaped with a curved section and a retaining tooth into which said second lower end of said movable connection element is slidably fitted.

16. The rolling shutter according to claim 11, wherein said fixed slat comprises at an upper edge thereof a seat shaped with a curved section and a retaining tooth into which said second lower end of said movable connection element is slidably fitted.

17. The rolling shutter according to claim 12, wherein said fixed slat comprises at an upper edge thereof a seat shaped with a curved section and a retaining tooth into which said second lower end of said movable connection element is slidably fitted.

18. The rolling shutter according to claim 2, wherein said movable wings comprise an upper claw-shaped portion that is received and couples within a corresponding lower seat of said lower slat which seat in turn has a curved development so as to allow the rotary movement of said claw within said seat in the opening and closing movement of the movable wing.

19. The rolling shutter according to claim 3, wherein said movable wings comprise an upper claw-shaped portion that is received and couples within a corresponding lower seat of said lower slat which seat in turn has a curved development so as to allow the rotary movement of said claw within said seat in the opening and closing movement of the movable wing.

20. The rolling shutter according to claim 4, wherein said movable wings comprise an upper claw-shaped portion that is received and couples within a corresponding lower seat of said lower slat which seat in turn has a curved development so as to allow the rotary movement of said claw within said seat in the opening and closing movement of the movable wing.
